(19) United States
(12) Patent Application Publication
(10) Pub. No.: US 2013/0173382 A1
(43) Pub. Date: Jul. 4, 2013

(54) CONVERSION ATTRIBUTION FOR EARNED MEDIA

(71) Applicants: TAL HASSON, Petach Tikva (IL); Nir Cohen, Rishon Letzion (IL); Yuval Lavi, Tel Aviv (IL)

(72) Inventors: TAL HASSON, Petach Tikva (IL); Nir Cohen, Rishon Letzion (IL); Yuval Lavi, Tel Aviv (IL)

(21) Appl. No.: 13/484,317

(22) Filed: May 31, 2012

Related U.S. Application Data
(60) Provisional application No. 61/582,516, filed on Jan. 3, 2012.

(51) Int. Cl. G06F 15/173; G06Q 30/00

(52) U.S. Cl. 705/14.45; 709/223

(57) ABSTRACT

Tracking a path to conversion by receiving, in relation to an engagement of a first computer user with a first computer-hosted media object, an identifier associated with the first computer user and an identifier associated with the first computer-hosted media object, receiving, in relation to an engagement of a second computer user to a second computer-hosted media object, the identifier associated with the first computer user, an identifier associated with the second computer user, and the identifier associated with the first computer-hosted media object, and associating with the engagement of the first computer user to the first computer-hosted media object, a conversion event associated with the second computer user.

### CROSS-REFERENCE TO RELATED APPLICATIONS

This application claims priority benefit from U.S. Provisional Patent Application No. 61/582,516 filed Jan. 3, 2012, which is incorporated herein by reference in its entirety.

### FIELD OF THE INVENTION

The present invention relates to Internet-based advertising in general, and more particularly to conversion attribution for earned media.

### BACKGROUND OF THE INVENTION

In Internet-based advertising, the term “paid media” typically refers to media that an advertiser pays for, such as for the display of an advertisement for a product (i.e., “paid impression”), and/or when a computer user “clicks” on an advertisement (i.e., “paid click”). Advertisers typically measure the success of Internet-based advertising campaigns in terms of “conversions,” which advertisers define in a variety of ways. For example, a conversion may be defined as a computer user viewing or interacting with an advertiser's paid media. Alternatively, a conversion may be defined as a computer user viewing or interacting with an advertiser's “owned media,” which may be the advertiser's web site or social network page, relating to an advertised product, to which the user was redirected as a result of the user's prior interaction with the advertiser's paid media. Alternatively, a conversion may be defined as a computer user purchasing an advertised product after interacting with the advertiser's paid media.

The term “earned media” typically refers to publicity from which an advertiser benefits, but which an advertiser does not pay for directly or at all. One example of earned media is a favorable review of a product that a computer user posts on a web site, such as on the product's Facebook™ page. Another example of earned media is when a computer user “clicks” on the product review. As interactions by computer users with earned media may lead to conversions, tracking such information may be useful to advertisers.

### SUMMARY OF THE INVENTION

In one aspect of the invention a method is provided for tracking a path to conversion, including receiving, in relation to an engagement of a first computer user with a first computer-hosted media object, an identifier associated with the first computer user and an identifier associated with the first computer-hosted media object, receiving, in relation to an engagement of a second computer user to a second computer-hosted media object, the identifier associated with the first computer user, an identifier associated with the second computer user, and the identifier associated with the first computer-hosted media object, and associating with the engagement of the first computer user to the first computer-hosted media object, a conversion event associated with the second computer user.

In another aspect of the invention the method further includes providing the second computer-hosted media object including the identifier associated with the first computer user and the identifier associated with the first computer-hosted media object.

In another aspect of the invention the method further includes detecting the conversion event.

In another aspect of the invention the method further includes providing to the first computer user, prior to performing the receiving steps, the identifier associated with the first computer user.

In another aspect of the invention the receiving and associating steps are performed where the first computer-hosted media object is a paid media object, and where the second computer-hosted media object is a non-paid media object.

In another aspect of the invention the receiving and associating steps are performed where the second computer-hosted media object is a paid media object, and where the first computer-hosted media object is a non-paid media object.

In another aspect of the invention the receiving and associating steps are performed where the first computer-hosted media object is a paid media object, and where the second computer-hosted media object is a paid media object.

In another aspect of the invention the receiving and associating steps are performed where the first computer-hosted media object is a non-paid media object, and where the second computer-hosted media object is a non-paid media object.

In another aspect of the invention the receiving and associating steps are performed where the second computer-hosted media object is created responsive to the exposure of the first computer user to the first computer-hosted media object.

In another aspect of the invention the receiving and associating steps are performed where any of the engagements occur within the context of a social network.

In another aspect of the invention the receiving and associating steps are performed where the first computer-hosted media object and the second computer-hosted media object have content in common.

In another aspect of the invention the receiving and associating steps are performed where the first computer-hosted media object is associated with a product, and where the second computer-hosted media object is associated with the product.

In another aspect of the invention the receiving and associating steps are performed where any of the media objects include any of an image object, a text object, an audio object, and a video object.

In another aspect of the invention the receiving and associating steps are performed where the conversion event is an interaction with an element of a computer-hosted document.

In another aspect of the invention the receiving and associating steps are performed where the conversion event is a computer-mediated acquisition.

In another aspect of the invention the receiving and associating steps are performed where the media objects are associated with a subject of the computer-mediated acquisition.

In another aspect of the invention the method further includes assigning a value to any of the engagements in accordance with a predefined function applied to a number of engagements that are descendants of the engagement to which the value is assigned.

In another aspect of the invention the method further includes creating an engagement graph any of the engagements and any other engagements that are descendants thereof.

In another aspect of the invention a system is provided for tracking a path to conversion, including a tracking manager configured to receive, in relation to an engagement of a first computer user with a first computer-hosted media object, an identifier associated with the first computer user and an identifier associated with the first computer-hosted media object, and receive, in relation to an engagement of a second computer user to a second computer-hosted media object, the identifier associated with the first computer user, an identifier associated with the second computer user, and the identifier associated with the first computer-hosted media object, and a conversion manager configured to associate with the engagement of the first computer user to the first computer-hosted media object, a conversion event associated with the second computer user.

In another aspect of the invention the tracking manager is configured to provide the second computer-hosted media object including the identifier associated with the first computer user and the identifier associated with the first computer-hosted media object.

In another aspect of the invention the conversion manager is configured to detect the conversion event.

In another aspect of the invention the system further includes an identifier manager configured to provide to the first computer user the identifier associated with the first computer user prior to the tracking manager receiving the identifier associated with the first computer user.

In another aspect of the invention the first computer-hosted media object is a paid media object, and where the second computer-hosted media object is a non-paid media object.

In another aspect of the invention the second computer-hosted media object is a paid media object, and where the first computer-hosted media object is a non-paid media object.

In another aspect of the invention the first computer-hosted media object is a paid media object, and where the second computer-hosted media object is a paid media object.

In another aspect of the invention the first computer-hosted media object is a non-paid media object, and where the second computer-hosted media object is a non-paid media object.

In another aspect of the invention the second computer-hosted media object is created responsive to the exposure of the first computer user to the first computer-hosted media object.

In another aspect of the invention any of the engagements occur within the context of a social network.

In another aspect of the invention the first computer-hosted media object and the second computer-hosted media object have content in common.

In another aspect of the invention the first computer-hosted media object is associated with a product, and where the second computer-hosted media object is associated with the product.

In another aspect of the invention any of the media objects include any of an image object, a text object, an audio object, and a video object.

In another aspect of the invention the conversion event is an interaction with an element of a computer-hosted document.

In another aspect of the invention the conversion event is a computer-mediated acquisition.

In another aspect of the invention the media objects are associated with a subject of the computer-mediated acquisition.

In another aspect of the invention the system further includes an engagement value manager configured to assign a value to any of the engagements in accordance with a predefined function applied to a number of engagements that are descendants of the engagement to which the value is assigned.

In another aspect of the invention the tracking manager is configured to create an engagement graph any of the engagements and any other engagements that are descendants thereof.

In another aspect of the invention a computer program product is provided for tracking a path to conversion, the computer program product including a computer-readable storage medium, and computer-readable program code embodied in the computer-readable storage medium, where the computer-readable program code is configured to receive, in relation to an engagement of a first computer user with a first computer-hosted media object, an identifier associated with the first computer user and an identifier associated with the first computer-hosted media object, receive, in relation to an engagement of a second computer user to a second computer-hosted media object, the identifier associated with the first computer user, an identifier associated with the second computer user, and the identifier associated with the first computer-hosted media object, and associate with the engagement of the first computer user to the first computer-hosted media object, a conversion event associated with the second computer user.

In another aspect of the invention the computer-readable program code is configured to provide the second computer-hosted media object including the identifier associated with the first computer user and the identifier associated with the first computer-hosted media object.

In another aspect of the invention the computer-readable program code is configured to detect the conversion event.

In another aspect of the invention the computer-readable program code is configured to provide to the first computer user the identifier associated with the first computer user prior to the tracking manager receiving the identifier associated with the first computer user.

In another aspect of the invention the first computer-hosted media object is a paid media object, and where the second computer-hosted media object is a non-paid media object.

In another aspect of the invention the second computer-hosted media object is a paid media object, and where the first computer-hosted media object is a non-paid media object.

In another aspect of the invention the first computer-hosted media object is a paid media object, and where the second computer-hosted media object is a paid media object.

In another aspect of the invention the first computer-hosted media object is a non-paid media object, and where the second computer-hosted media object is a non-paid media object.

In another aspect of the invention the second computer-hosted media object is created responsive to the exposure of the first computer user to the first computer-hosted media object.

In another aspect of the invention any of the engagements occur within the context of a social network.

In another aspect of the invention the first computer-hosted media object and the second computer-hosted media object have content in common.

In another aspect of the invention the first computer-hosted media object is associated with a product, and where the second computer-hosted media object is associated with the product.

In another aspect of the invention any of the media objects include any of an image object, a text object, an audio object, and a video object.

In another aspect of the invention the conversion event is an interaction with an element of a computer-hosted document.

In another aspect of the invention the conversion event is a computer-mediated acquisition.

In another aspect of the invention the media objects are associated with a subject of the computer-mediated acquisition.

In another aspect of the invention the computer-readable program code is configured to assign a value to any of the engagements in accordance with a predefined function applied to a number of engagements that are descendants of the engagement to which the value is assigned. In another aspect of the invention the computer-readable program code is configured to create an engagement graph any of the engagements and any other engagements that are descendants thereof.

In various embodiments of the invention the term “media object” as used herein refers to any object that can be displayed on a computer display or otherwise presented via a computer-controlled output device, such as where the object includes text, image, audio, or video data, or any combination thereof.

In various embodiments of the invention the term “computer user” as used herein refers to any entity that may be exposed to a media object, such as human computer users or computer software applications such as automated crawlers.

In various embodiments of the invention the terms “engagement,” “exposed” and “exposure” as used herein refers any type of encounter or interaction with a media object, such as where a computer user views and/or hears a media object, “clicks” on a media object using a pointing device, or otherwise interacts with a media object.

### BRIEF DESCRIPTION OF THE DRAWINGS

The invention will be understood and appreciated more fully from the following detailed description taken in conjunction with the appended drawings in which:

FIG. 1A is a simplified conceptual illustration of a system for determining conversion attribution, constructed and operative in accordance with an embodiment of the invention;

FIG. 1B is a simplified conceptual illustration of an engagement graph, constructed and operative in accordance with an embodiment of the invention; and

FIGS. 2A and 2B, taken together, is a simplified action diagram of an exemplary method of operation of the system of FIG. 1, operative in accordance with an embodiment of the invention.

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

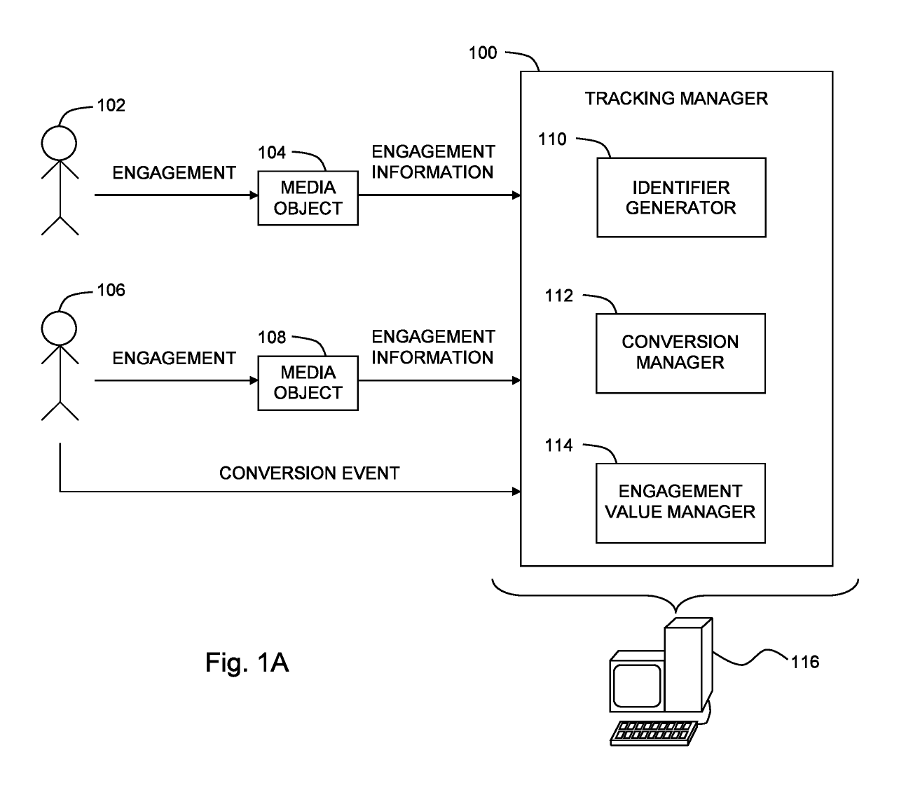

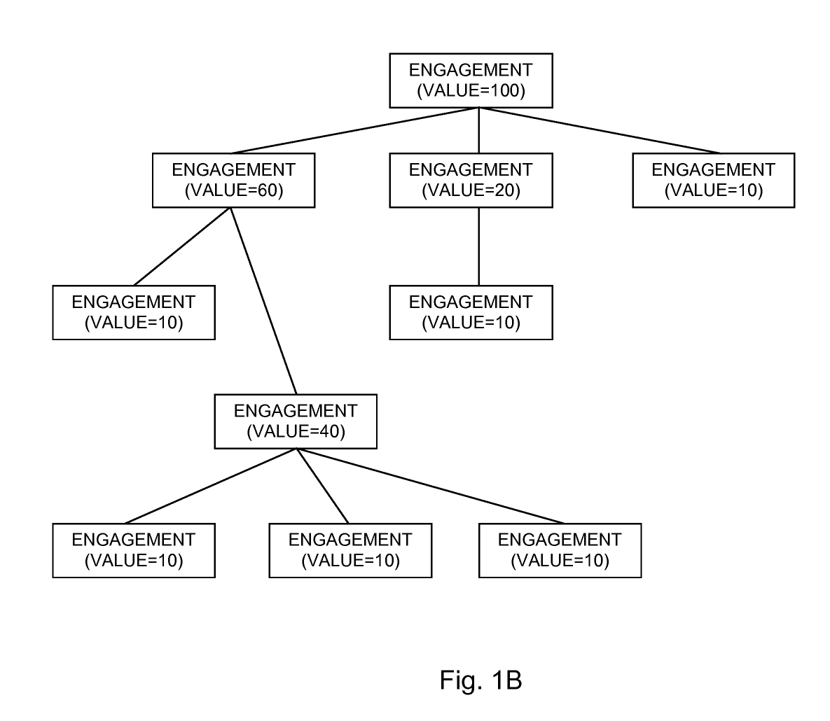

Reference is now made to FIG. 1A, which is a simplified conceptual illustration of a system for determining conversion attribution, constructed and operative in accordance with an embodiment of the invention. In the system of FIG. 1A, a tracking manager 100 is configured to receive engagement information, such as may include an identifier associated with a computer user 102 and an identifier associated with a computer-hosted media object 104, in relation to an engagement of computer user 102 with computer-hosted media object 104. Tracking manager 100 is also configured to receive engagement information, such as may include an identifier associated with computer user 102, an identifier associated with a computer user 106, and the identifier associated with computer-hosted media object 104, in relation to an engagement of computer user 106 with a computer-hosted media object 108. Tracking manager 100 preferably includes an identifier generator 110 configured to associate a unique identifier with a computer user when the computer user is first encountered and provide the identifier to the computer user, such as in the form of a cookie for storage by a computer-based browser. Tracking manager 100 also preferably includes a conversion manager 112 configured to associate a conversion event, such as may be detected by conversion manager 112, with the engagement of computer user 102 with computer-hosted media object 104, where the conversion event is associated with computer user 106.

Tracking manager 100 also preferably includes an engagement value manager 114 configured to assign a value to any engagements of computer users with computer-hosted media objects in accordance with a predefined function applied to the number of such engagements that are descendants of the engagement to which the value is assigned. Thus, for example, where the engagement of computer user 102 with computer-hosted media object 104 results in the creation of computer-hosted media object 108, the subsequent engagement of computer user 106 with computer-hosted media object 108 is considered to be a descendent of the engagement of computer user 102 with computer-hosted media object 104. Similarly, the subsequent engagements of other computer users with computer-hosted media object 108 are considered to be descendants of the engagement of computer user 102 with computer-hosted media object 104. Furthermore, if any of the descendent engagements result in the creation of third-generation computer-hosted media objects, the subsequent engagement of computer users with the third-generation computer-hosted media objects are considered to be descendants of both the engagement of computer user 102 with computer-hosted media object 104, as well as of the engagements of computer users with computer-hosted media object 108. In this manner, any number of engagements and descendants may be tracked for any number of generations of computer-hosted media objects, and an engagement graph of engagements and their descendants may be constructed, such as is shown in FIG. 1B, where each engagement is represented as a node and, optionally, a value, and, if applicable, one or more conversion events. Engagement value manager 114 may, for example, assign to an engagement a value corresponding to the number of descendants of the engagement. Alternatively, engagement value manager 114 may assign to an engagement a base value for the engagement itself plus the sum of the values of its children, such as is shown in FIG. 1B where each engagement is assigned a base value of 10 plus the values of its children, who are themselves assigned a base value of 10 plus the values of their children, and so on. Descendent generations may also be weighted by multiplying their base values and/or the sum of the values of their children by different multipliers for different generations or by the number of their descendants. Such weighting may also vary according to the type of engagement and the event that it represents.

Any of the elements shown in FIG. 1A are preferably implemented by one or more computers, such as by a computer 116, in computer hardware and/or in computer software embodied in a non-transitory, computer-readable medium in accordance with conventional techniques. Any of the communications described herein is preferably conducted via a computer network, such as the Internet.

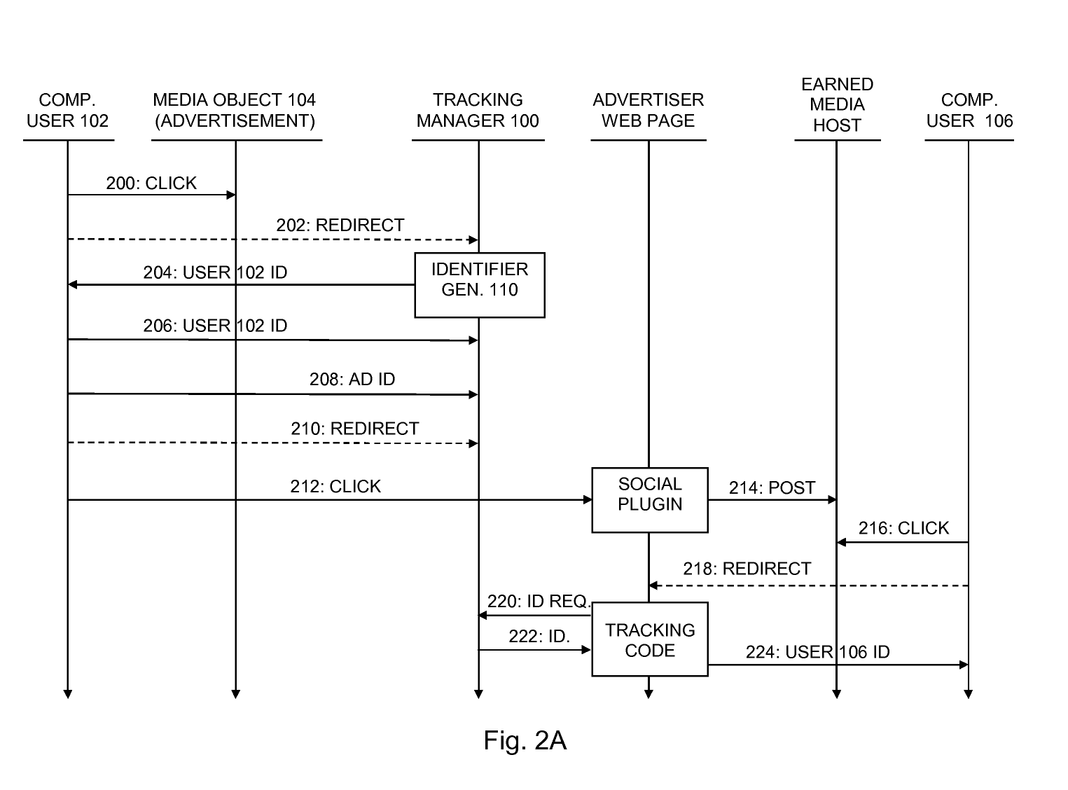

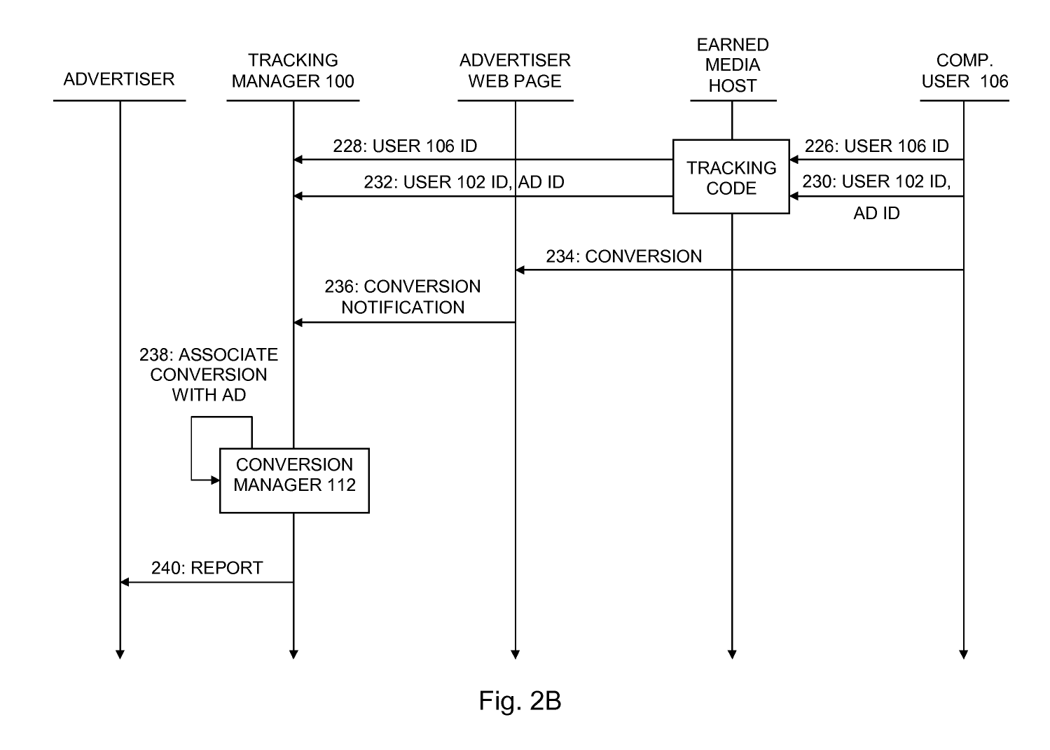

Reference is now made to FIGS. 2A and 2B, which, taken together, is a simplified action diagram of an exemplary method of operation of the system of FIG. 1, operative in accordance with an embodiment of the invention. In the method of FIGS. 2A and 2B, computer user 102 “clicks” on computer-hosted media object 104 using a pointing device, such as where computer-hosted media object 104 is an advertisement for a tennis racket in a web page displayed by a computer-based browser (step 200). Computer user 102 is redirected to communicate with tracking manager 100, such as at a computer network address indicated by a URL within the web page that is associated with the advertisement (step 202). If computer user 102 is not known to tracking manager 100, identifier generator 110 associates a unique identifier with computer user 102 and provides the identifier to computer user 102, such as in a cookie that is to be retained by computer user 102's browser (step 204). If computer user 102 is known to tracking manager 100, having previously received such an identifier, there is no need to generate a new identifier. Computer user 102's browser provides the identifier to tracking manager 100 (step 206). Computer user 102's browser also provides to tracking manager 100 an identifier associated with the advertisement, such as may be indicated within the web page (step 208). Tracking manager 100 preferably records computer user 102's “clicks” on computer-hosted media object 104 as a “click event.”

Computer user 102 is then redirected to the advertiser's web page, such as by tracking manager 100, where the URL includes a parameter that indicates the advertiser's web page. At this stage, the identifiers associated with user 102 and the advertisement are transferred to the advertiser web page as parameters in the URL. The advertiser web page preferably includes tracking code, such as in the form of a tracking pixel, that enables the advertiser's web page to that can extract these parameters from the URL.

Once at the advertiser's web page, computer user 102 clicks on a social plugin (step 212) which is configured such that it creates earned media in the form of computer-hosted media object 108 including a reference to the tennis racket that is posted to an earned media host, such as on computer user 102's web page of a social network like Facebook™ and on web pages of other computer users, such as in the form of a news feed, on the same or other social networks that are associated with computer user 102 via computer user 102's social network. Computer-hosted media object 108 is posted together with an associated “sensor” that includes a hypertext link to the advertiser's web page including the identifier of computer user 102 and the identifier of the advertisement/computer-hosted media object 104 (step 214). Tracking manager 100 preferably records computer user 102's “clicks” on the social plugin as a “fan event.”

Computer user 106 sees computer-hosted media object 108, such as on his social network's news feed, and clicks on it (step 216). Computer user 106 is redirected to the advertiser's web page by the hypertext link in the sensor associated with the posting, and provides the identifier of computer user 102 and the identifier of the original advertisement/computer-hosted media object 104 to the advertiser's web page (step 218). The advertiser's web page includes tracking code, such as in the form of a tracking pixel that enables the advertiser's web page to request an identifier of computer user 106 that may have been previously provided to computer user 106 by identifier generator 110, such as in a cookie that is retained by computer user 106's browser. If computer user 106 does not have such an identifier, the tracking code informs tracking manager 100 of this (step 220), whereupon identifier generator 110 associates a unique identifier with computer user 106 and provides the identifier to the tracking code (step 222), which then provides the identifier to computer user 106, such as in a cookie that is to be retained by computer user 106's browser (step 224). Alternatively, the tracking code is configured to dynamically generate a unique identifier for computer user 106. If computer user 106 previously received such an identifier, computer user 106's browser provides the identifier to the tracking code (step 226), which in turn provides computer user 106's identifier to tracking manager 100 (step 228). Computer user 106 also provides the identifier associated with the advertisement/computer-hosted media object 104 and the identifier associated with computer user 102 (step 230), which the tracking code provides to tracking manager 100 (step 232). Tracking manager 100 preferably records computer user 106's “click” on computer-hosted media object 108 as an “earned click event.”

Computer user 106 purchases the tennis racket at the advertiser's web site, which purchase represents a conversion event (step 234). A notification of the conversion event is sent to tracking manager 100, such as by tracking code included in a post-purchase “thank you” web page at the advertiser's web site, together with the identifiers associated with computer user 102, computer user 106, and the advertisement/computer-hosted media object 104 (step 236). Conversion manager 112 preferably associates the conversion event with the engagement of computer user 102 with the advertisement/computer-hosted media object 104, with any engagements that are descendants of the engagement, or with any combination of such engagements (step 238). The engagement of computer user 102 with the advertisement/computer-hosted media object 104 and its descendent engagements up to and including the conversion event may be viewed as representing a “path to conversion” from advertisement/computer-hosted media object 104 to the conversion event. Tracking manager 100 preferably reports any of the conversion event associations and/or the “path to conversion” information to the advertiser (step 240).

It is appreciated that any information regarding any engagements as described hereinabove may be received by tracking manager 100 in accordance with conventional techniques, classified by tracking manager 100 using any classification criteria, recorded by tracking manager 100 using any data storage media and conventional data storage techniques, such as in a data center, and provided for reporting in accordance with conventional techniques. Thus, for example, tracking manager 100 may, as described above, receive, classify, record and report on computer user 102's engagement with computer-hosted media object 104 (step 200) as a “click event,” computer user 102's engagement with the social plugin on the advertiser's web page (step 212) as a “fan event,” computer user 106's engagement with computer-hosted media object 108 (step 216) as an “earned click event,” and computer user 106's purchase as an “earned conversion event.” Tracking manager 100 may receive, classify, record and report engagements by any user, engagements per advertisement, and conversion events per advertisement, as well as engagement values and associations of conversion events with engagements such as may be maintained in an engagement graph as described hereinabove with reference to FIG. 1A. In this manner, different paths to conversion may be dynamically defined by defining what constitutes a conversion event (e.g., an engagement, an engagement with paid media, an engagement with earned media, a purchase of a product as a result of an engagement, etc.).

It is appreciated that the system of FIG. 1 and the exemplary method of operation of FIGS. 2A and 2B may be adapted for use with any type of engagement, such as a computer user clicking on a sponsored ad that appears on a search engine results page, a computer user providing a notification of his current location using a location-based social networking website for mobile devices such as Foursquare™, a computer user clicking on a multimedia object on a web page in order to play audio and/or video content, or a computer user clicking on a banner-type display advertisement. It is further appreciated that the tracking of engagements and their descendants as described hereinabove may begin with any type of engagement beside a click event, such as with a fan event or an earned fan event.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for tracking a path to conversion, the method comprising:
receiving, in relation to an engagement of a first computer user with a first computer-hosted media object, an identifier associated with the first computer user and an identifier associated with the first computer-hosted media object;
receiving, in relation to an engagement of a second computer user to a second computer-hosted media object, the identifier associated with the first computer user, an identifier associated with the second computer user, and the identifier associated with the first computer-hosted media object; and
associating with the engagement of the first computer user to the first computer-hosted media object, a conversion event associated with the second computer user.

2. The method according to claim 1 and further comprising providing the second computer-hosted media object including the identifier associated with the first computer user and the identifier associated with the first computer-hosted media object.

3. The method according to claim 1 and further comprising detecting the conversion event.

4. The method according to claim 1 and further comprising providing to the first computer user, prior to performing the receiving steps, the identifier associated with the first computer user.

5. The method according to claim 1 wherein the receiving and associating steps are performed wherein the first computer-hosted media object is a paid media object, and wherein the second computer-hosted media object is a non-paid media object.

6. The method according to claim 1 wherein the receiving and associating steps are performed wherein the second computer-hosted media object is a paid media object, and wherein the first computer-hosted media object is a non-paid media object.

7. The method according to claim 1 wherein the receiving and associating steps are performed wherein the first computer-hosted media object is a paid media object, and wherein the second computer-hosted media object is a paid media object.

8. The method according to claim 1 wherein the receiving and associating steps are performed wherein the first computer-hosted media object is a non-paid media object, and wherein the second computer-hosted media object is a non-paid media object.

9. The method according to claim 1 wherein the receiving and associating steps are performed wherein the second computer-hosted media object is created responsive to the exposure of the first computer user to the first computer-hosted media object.

10. The method according to claim 1 wherein the receiving and associating steps are performed wherein any of the engagements occur within the context of a social network.

11. The method according to claim 1 wherein the receiving and associating steps are performed wherein the first computer-hosted media object and the second computer-hosted media object have content in common.

12. The method according to claim 1 wherein the receiving and associating steps are performed wherein the first computer-hosted media object is associated with a product, and wherein the second computer-hosted media object is associated with the product.

13. The method according to claim 1 wherein the receiving and associating steps are performed wherein any of the media objects include any of an image object, a text object, an audio object, and a video object.

14. The method according to claim 1 wherein the receiving and associating steps are performed wherein the conversion event is an interaction with an element of a computer-hosted document.

15. The method according to claim 1 wherein the receiving and associating steps are performed wherein the conversion event is a computer-mediated acquisition.

16. The method according to claim 15 wherein the receiving and associating steps are performed wherein the media objects are associated with a subject of the computer-mediated acquisition.

17. The method according to claim 1 and further comprising assigning a value to any of the engagements in accordance with a predefined function applied to a number of engagements that are descendants of the engagement to which the value is assigned.

18. The method according to claim 1 and further comprising creating an engagement graph any of the engagements and any other engagements that are descendants thereof.

19. A system for tracking a path to conversion, the system comprising:
a tracking manager configured to
receive, in relation to an engagement of a first computer user with a first computer-hosted media object, an identifier associated with the first computer user and an identifier associated with the first computer-hosted media object, and
receive, in relation to an engagement of a second computer user to a second computer-hosted media object, the identifier associated with the first computer user, an identifier associated with the second computer user, and the identifier associated with the first computer-hosted media object; and
a conversion manager configured to associate with the engagement of the first computer user to the first computer-hosted media object, a conversion event associated with the second computer user.

20. The system according to claim 19 wherein the tracking manager is configured to provide the second computer-hosted media object including the identifier associated with the first computer user and the identifier associated with the first computer-hosted media object.

21. The system according to claim 19 wherein the conversion manager is configured to detect the conversion event.

22. The system according to claim 19 and further comprising an identifier manager configured to provide to the first computer user the identifier associated with the first computer user prior to the tracking manager receiving the identifier associated with the first computer user.

23. The system according to claim 19 wherein the first computer-hosted media object is a paid media object, and wherein the second computer-hosted media object is a non-paid media object.

24. The system according to claim 19 wherein the second computer-hosted media object is a paid media object, and wherein the first computer-hosted media object is a non-paid media object.

25. The system according to claim 19 wherein the first computer-hosted media object is a paid media object, and wherein the second computer-hosted media object is a paid media object.

26. The system according to claim 19 wherein the first computer-hosted media object is a non-paid media object, and wherein the second computer-hosted media object is a non-paid media object.

27. The system according to claim 19 wherein the second computer-hosted media object is created responsive to the exposure of the first computer user to the first computer-hosted media object.

28. The system according to claim 19 wherein any of the engagements occur within the context of a social network.

29. The system according to claim 19 wherein the first computer-hosted media object and the second computer-hosted media object have content in common.

30. The system according to claim 19 wherein the first computer-hosted media object is associated with a product, and wherein the second computer-hosted media object is associated with the product.

31. The system according to claim 19 wherein any of the media objects include any of an image object, a text object, an audio object, and a video object.

32. The system according to claim 19 wherein the conversion event is an interaction with an element of a computer-hosted document.

33. The system according to claim 19 wherein the conversion event is a computer-mediated acquisition.

34. The system according to claim 33 wherein the media objects are associated with a subject of the computer-mediated acquisition.

35. The system according to claim 19 and further comprising an engagement value manager configured to assign a value to any of the engagements in accordance with a predefined function applied to a number of engagements that are descendants of the engagement to which the value is assigned.

36. The system according to claim 19 wherein the tracking manager is configured to create an engagement graph any of the engagements and any other engagements that are descendants thereof.

37. A computer program product for tracking a path to conversion, the computer program product comprising:
a computer-readable storage medium; and
computer-readable program code embodied in the computer-readable storage medium, wherein the computer-readable program code is configured to
receive, in relation to an engagement of a first computer user with a first computer-hosted media object, an identifier associated with the first computer user and an identifier associated with the first computer-hosted media object,
receive, in relation to an engagement of a second computer user to a second computer-hosted media object, the identifier associated with the first computer user, an identifier associated with the second computer user, and the identifier associated with the first computer-hosted media object, and
associate with the engagement of the first computer user to the first computer-hosted media object, a conversion event associated with the second computer user.

38. The computer program product according to claim 37 wherein the computer-readable program code is configured to provide the second computer-hosted media object including the identifier associated with the first computer user and the identifier associated with the first computer-hosted media object.

39. The computer program product according to claim 37 wherein the computer-readable program code is configured to detect the conversion event.

40. The computer program product according to claim 37 wherein the computer-readable program code is configured to provide to the first computer user the identifier associated with the first computer user prior to the tracking manager receiving the identifier associated with the first computer user.

41. The computer program product according to claim 37 wherein the first computer-hosted media object is a paid media object, and wherein the second computer-hosted media object is a non-paid media object.

42. The computer program product according to claim 37 wherein the second computer-hosted media object is a paid media object, and wherein the first computer-hosted media object is a non-paid media object.

43. The computer program product according to claim 37 wherein the first computer-hosted media object is a paid media object, and wherein the second computer-hosted media object is a paid media object.

44. The computer program product according to claim 37 wherein the first computer-hosted media object is a non-paid media object, and wherein the second computer-hosted media object is a non-paid media object.

45. The computer program product according to claim 37 wherein the second computer-hosted media object is created responsive to the exposure of the first computer user to the first computer-hosted media object.

46. The computer program product according to claim 37 wherein any of the engagements occur within the context of a social network.

47. The computer program product according to claim 37 wherein the first computer-hosted media object and the second computer-hosted media object have content in common.

48. The computer program product according to claim 37 wherein the first computer-hosted media object is associated with a product, and wherein the second computer-hosted media object is associated with the product.

49. The computer program product according to claim 37 wherein any of the media objects include any of an image object, a text object, an audio object, and a video object.

50. The computer program product according to claim 37 wherein the conversion event is an interaction with an element of a computer-hosted document.

51. The computer program product according to claim 37 wherein the conversion event is a computer-mediated acquisition.

52. The computer program product according to claim 51 wherein the media objects are associated with a subject of the computer-mediated acquisition.

53. The computer program product according to claim 37 wherein the computer-readable program code is configured to assign a value to any of the engagements in accordance with a predefined function applied to a number of engagements that are descendants of the engagement to which the value is assigned.

54. The computer program product according to claim 37 wherein the computer-readable program code is configured to create an engagement graph any of the engagements and any other engagements that are descendants thereof.
